(19) United States
(12) Patent Application Publication
(10) Pub. No.: US 2026/0309129 A1
(43) Pub. Date: Oct. 8, 2026

(54) BLADE GUIDING APPARATUS

(71) Applicant: Vestas Wind Systems A/S, Aarhus N. (DK)

(72) Inventors: Martin Werner Nielsen, Svenstrup J (DK); Søren Topp, NyKøbing F (DK)

(73) Assignee: Vestas Wind Systems A/S, Aarhus N. (DK)

(21) Appl. No.: 19/482,256

(22) PCT Filed: Apr. 30, 2024
(86) PCT No.: PCT/DK2024/050097

§ 371 Date: Nov. 7, 2025

(30) Foreign Application Priority Data
May 10, 2023 (DK) PA 2023 70229

(51) Int. Cl. F03D 13/10; F03D 1/06

(52) U.S. Cl. CPC F03D 13/108; F03D 1/0658; F05B 2230/604; F05B 2240/21

(57) ABSTRACT

The present disclosure relates to a blade guiding apparatus for facilitating connection between a wind turbine blade and a rotor hub. The blade guiding apparatus has a guide and a cushion which is carried by said guide. The cushion is provided for interfacing with a wind turbine blade or with a rotor hub to create an interference fit between the guide and the wind turbine blade or rotor hub. The provision of a cushion helps to absorb and/or dampen impacts which may be encountered during installation due to relative movement between the wind turbine blade and the rotor hub.

### FIELD OF THE INVENTION

The present invention relates to a blade guiding apparatus for facilitating connection between a wind turbine blade and a rotor hub, a wind turbine comprising said blade guiding apparatus and a method of using the same.

### BACKGROUND OF THE INVENTION

In modern wind turbines, the wind turbine blades are typically mounted to the rotor hub via a series of bolts which are provided at the root end of the turbine blade and become located within corresponding boltholes provided at the rotor hub (or vice versa). A single blade may feature as many as fifty or more bolts to facilitate connection between the blade root and the rotor hub and so, due to the size and weight of modern wind turbine blades, manoeuvring the blades so that each bolt is correctly aligned with its corresponding bolthole is extremely difficult.

One way in which this problem can be addressed is by providing one or more guide rods at the rotor hub which are configured to engage with a corresponding slot provided at the root end of the blade to help in bringing the two components into alignment.

However, since the rotor hub is typically installed atop the tower section when the turbine blades are attached, the wind turbine (and the blades to be attached to the wind turbine) can be exposed to high winds which can cause the rotor hub and blades to move relative to one another. Furthermore, when the wind turbine is installed in an offshore location, waves and/or other tidal motions can also act on the wind turbine which further increases the amount of relative movement between the blades and the rotor hub.

As such, when the wind turbine blades and rotor hub are being brought together for connection, there is a significant risk that relative movements between the rotor hub and the wind turbine blade may cause the guide rods to impact against and damage the bolts and/or surfaces of the blade or rotor hub. Therefore, even with guide rods, the process of connecting one or more turbines blades to a rotor hub is an extremely challenging and potentially dangerous process.

It is therefore an aim of the present invention to provide a solution to this problem.

### SUMMARY OF THE INVENTION

A first aspect of the invention provides a blade guiding apparatus for facilitating connection between a wind turbine blade and a rotor hub, the blade guiding apparatus comprising:
a guide; and
a cushion carried by said guide for forming an interference fit with a wind turbine blade or with a rotor hub.

Advantageously, the provision of a cushion which forms an interference fit with a wind turbine or rotor hub helps to reduce relative movement between the turbine blade and rotor hub during installation thereby allowing an operator to align and connect the turbine blade to the rotor hub more easily.

Furthermore, the cushion also acts to dampen any incidental impacts which may occur between the guide and the connectors provided on the rotor hub or turbine blade during installation, thereby helping to reduce the risk of damage.

In some examples, the cushion may be an inflatable cushion.

In some examples, the cushion may extend around a circumference of the guide.

In some examples, the cushion may be substantially torus-shaped (i.e., doughnut shaped).

In some examples, the guide may comprise a first post and a second post, and the cushion may be carried between the first and second posts.

In some examples, the blade guiding apparatus may comprise a plurality of guides, and each guide may carry a respective cushion.

In some examples, each cushion may be independently inflatable.

We consider the term “independently inflatable” to mean that each cushion can be inflated and/or deflated independently of the other cushions.

In some examples, the blade guiding apparatus may comprise a pumping device (e.g., a compressor) configured to actuate the or each cushion from an uninflated condition to an inflated condition.

In some examples, the or each cushion may be associated with a valve for providing a controllable fluid connection between the pumping device and the cushion.

In some examples, the or each cushion may be associated with a valve for providing a controllable fluid connection between the cushion and the ambient atmosphere.

In some examples, the or each cushion may be associated with a first valve for providing a controllable fluid connection between the pumping device and the cushion and a second valve for providing a controllable fluid connection between the cushion and the ambient atmosphere.

In some examples, each cushion may be fluidly connected to the pumping device via a manifold.

In some examples, the first and/or second valves may be provided at said manifold.

In some examples, the or each guide may be formed from a plurality of releasably connectable sections.

In some examples, the weight of each section may be less than 20 kg.

In some examples, the cushion may be configured to form an interference fit with an internal surface of the wind turbine blade.

In some examples, the cushion may be configured to form an interference fit with an internal surface of the rotor hub.

We consider the term “internal surface” to encompass any surface which is not an external surface.

We consider the term “external surface” to be defined as a surface which is exposed to aerodynamic forces or airflow during use.

In some examples, the internal surface may be the inner surface of a part which makes up the body of the wind turbine blade or rotor hub.

In some examples, the internal surface may be a surface which is provided inside the body of the wind turbine blade or rotor hub.

A second aspect of the invention provides a wind turbine comprising:
a rotor hub;
a wind turbine blade; and
the blade guiding apparatus according to the first aspect of the invention, wherein the guide is mounted to one of the rotor hub or the wind turbine blade, and wherein the cushion is configured to form an interference fit the other of the rotor hub or the wind turbine blade.

In some examples, the blade guiding apparatus may comprise a plurality of guides, and the plurality of guides may be provided at different positions about a circumference of the rotor hub or wind turbine blade.

In some examples, a first guide may be provided at a first position about the circumference of the rotor hub or wind turbine blade, a second guide may be provided at a second position about the circumference of the rotor hub or wind turbine blade, and the first and second positions may be separated by an angle of approximately 180 degrees.

In some examples, the guide may be mounted to the rotor hub and the cushion may be configured to form an interference fit with the wind turbine blade.

In some examples, the guide may be mounted to the wind turbine blade and the cushion may be configured to form an interference fit with the rotor hub.

A third aspect of the invention provides a method of securing a wind turbine blade to a rotor hub using the blade guiding apparatus according to the first aspect of the invention, the method comprising:
a) mounting the guide to one of a rotor hub or a wind turbine blade;
b) locating at least part of the guide in the other of the rotor hub or the wind turbine blade; and
c) forming an interference fit between the cushion carried by the guide and the rotor hub or wind turbine blade into which the guide is located.

In some examples, the cushion may be an inflatable cushion, and the method may further comprise at least partially inflating the cushion prior to locating at least part of the guide in the rotor hub or wind turbine blade.

In some examples, the cushion may be an inflatable cushion, and the method may comprise, after locating the guide in the rotor hub or wind turbine blade, inflating or further inflating the cushion from a first condition, in which the cushion does not form an interference fit with the rotor hub or wind turbine blade, to a second condition, in which the cushion forms an interference fit with the wind turbine blade or rotor hub.

In some examples, the blade guiding apparatus may comprise a plurality of independently inflatable cushions, and the method may further comprise, after locating the guide in the rotor hub or wind turbine blade, selectively inflating and/or deflating one or more of the plurality of cushions so as to align the wind turbine blade with the rotor hub.

In some examples, the guide may comprise a root portion and a tip portion for carrying the cushion.

In some examples, the blade may be secured to the rotor hub via a first set of connectors which are accessible when the blade is at a first pitch and a second set of connectors which are inaccessible when the blade is at the first pitch.

In some examples, the method may comprise:
d) securing the wind turbine blade to the rotor hub via the first set of connectors;
e) detaching the tip portion of the guide from the root portion of the guide;
f) detaching the root portion of the guide from the rotor hub whilst the tip portion of the guide remains secured to the wind turbine blade via the interference fit formed between the cushion and the wind turbine blade;
g) rotating the wind turbine blade from a first pitch to a second pitch in which the second set of connectors are accessible; and
h) securing the wind turbine blade to the rotor hub via the second set of connectors.

### BRIEF DESCRIPTION OF THE DRAWINGS

Examples of the invention will now be described with reference to the accompanying drawings, in which:

FIG. 1 is a front view of a wind turbine;

FIG. 2 is a perspective view of a rotor hub having a blade guiding apparatus according to one example of the present disclosure;

FIG. 3 is a perspective view of an interface between a rotor hub and the root end of a wind turbine blade;

FIG. 4a is a perspective view of the blade guiding apparatus illustrated in FIG. 2;

FIG. 4b is a rear view of the blade guiding apparatus illustrated in FIG. 4a;

FIG. 4c is a side view of the blade guiding apparatus illustrated in FIG. 4a at an interface between a rotor hub and the root end of a wind turbine blade;

FIG. 5a is a perspective view of a blade guiding apparatus according to another example of the present disclosure;

FIG. 5b is a side view of the blade guiding apparatus illustrated in FIG. 5a at an interface between a rotor hub and the root end of a wind turbine blade;

FIG. 6 is a perspective view of a blade guiding apparatus according to yet another example of the present disclosure;

FIG. 7a is a front view of the blade guiding apparatus illustrated in FIGS. 5a and 5b in which the cushions are in a first (partially inflated) condition;

FIG. 7b is a front view of a blade guiding apparatus illustrated in FIGS. 5a and 5b in which the cushions are in a second (fully inflated) condition;

FIG. 8 is a perspective view of a manifold for providing a controllable fluid connection between the cushions of the blade guiding apparatus illustrated in FIGS. 7a and 7b and a pumping device (e.g., a compressor); and

FIG. 9 is a flow chart depicting a method according to one example of the present disclosure.

### DETAILED DESCRIPTION OF EMBODIMENT(S)

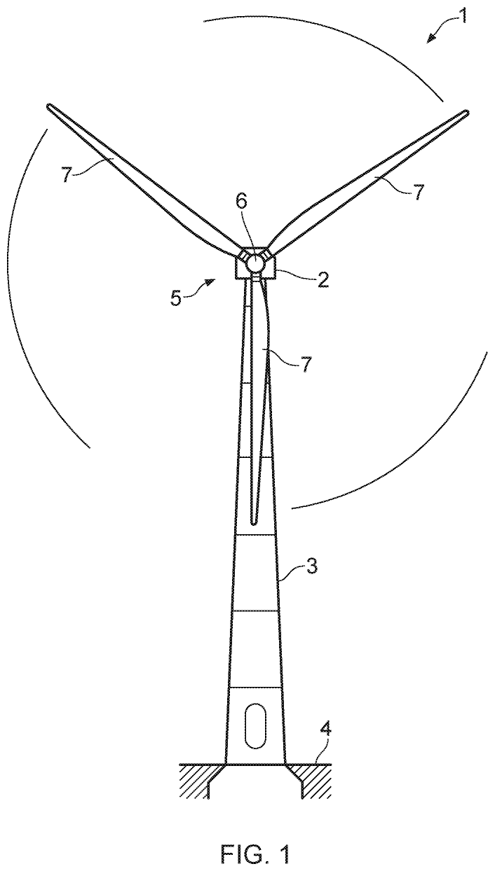

FIG. 1 shows a wind turbine 1 including a nacelle 2 supported on a tower 3 that is mounted on a foundation 4. The wind turbine 1 depicted here is an onshore wind turbine such that the foundation 4 is embedded in the ground, but the wind turbine 1 could be an offshore installation in which case the foundation 4 would be provided by a suitable marine platform, such as a monopile or jacket.

The nacelle 2 supports a rotor 5 comprising a hub 6 to which three blades 7 are attached. The blades 7 which make up the rotor 5 of the wind turbine 1 each comprise a tip end, which is located distal from the hub 6, and a root end, which is located proximal to the hub 6.

It will be noted that the wind turbine 1 is the common type of horizontal axis wind turbine (HAWT) such that the rotor 5 is mounted at the nacelle 2 to rotate about a substantially horizontal axis defined at the centre at the hub 6. As is known, the blades 7 are acted on by the wind which causes the rotor 5 to rotate about its axis thereby operating generating equipment through a gearbox (not shown) that is housed in the nacelle 2.

The generating equipment is not shown in FIG. 1 since it is not central to the examples of the invention.

During installation of the wind turbine 1, the tower 3 is first installed onto the foundation 4 (or marine platform if the wind turbine 1 is an offshore installation). The tower 3 may be installed via stacking a plurality of tower sections one atop the other (as shown in FIG. 1), or alternatively the tower 3 may be provided as a single, monolithic structure.

Once the tower 3 has been installed onto the foundation 4 or marine platform, the nacelle 2 is hoisted and positioned atop the tower 3. The generating equipment such as the generator, gearbox, rotor shaft etc. can then be loaded into the nacelle 2 and installed. Once installed, a portion of the rotor shaft will protrude out of the front of the nacelle 2 to which the rotor hub 6 is mounted. Finally, the installation is completed via connecting each of the wind turbine blades 7 one by one to corresponding mountings provided at the rotor hub 6.

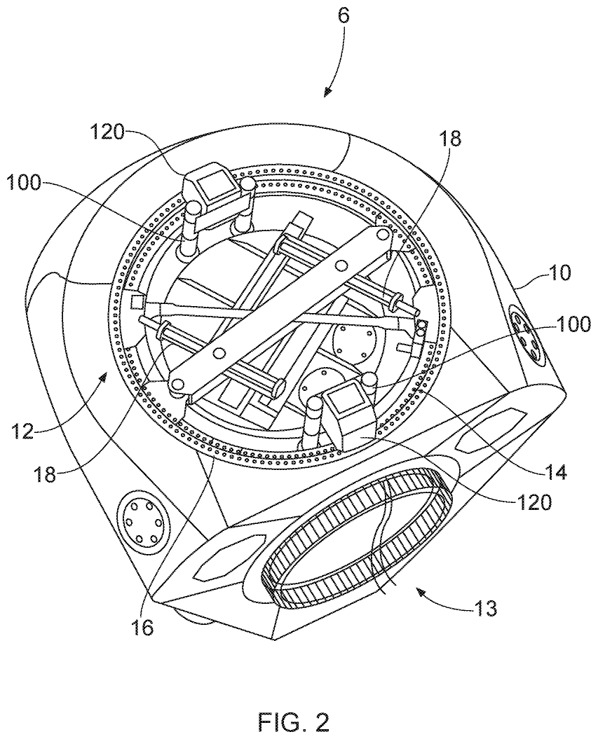

The rotor hub 6 is illustrated in greater detail in FIG. 2.

Referring to FIG. 2, the rotor hub 6 has a body 10 which is roughly spheroidal in shape. Typically, the body 10 is provided as a single cast-iron casting and hence constitutes a single unitary structure. However, in other examples, the body 10 of the rotor hub 6 may be provided in multiple sections. The body 10 of the rotor hub 6 is substantially hollow and hence a cavity is defined therein.

A plurality of mountings 12 are disposed about the body 10 of the rotor hub 6 to which one or more wind turbine blades 7 can be coupled. The rotor hub 6 illustrated in FIG. 2 comprises three mountings 12 (although only one mounting is shown in FIG. 2) which are disposed about the circumference of the rotor hub 6 at intervals of approximately 120 degrees. Consequently, the rotor hub 6 depicted in FIG. 2 is configured for carrying three turbine blades 7. However, in other examples, the rotor hub 6 may comprise a different number of mountings, such as 2, 4, 5, 6 etc., and hence in some examples, the rotor hub 6 may carry less than three turbine blades or more than three turbine blades.

In examples where the number of mountings is less than or greater than three, the mountings may be disposed about the circumference of the rotor hub 6 at intervals which are more or less than 120 degrees. For instance, in some examples, the plurality of mountings may be disposed about the circumference of the rotor hub 6 at intervals of 360/N degrees, wherein N is the number of mountings/turbine blades.

In the example illustrated in FIG. 2, a further mounting 13 is also provided at the rotor hub 6 to facilitate connection between the rotor hub 6 and the rotor shaft (not shown) which is housed within the nacelle 2.

A rotatable bearing 16 (or pitch bearing) is rotatably coupled to each mounting 12. In the illustrated example, the rotatable bearing 16 is provided as a substantially ring-shaped structure and extends around an outer circumference of the mounting 12. However, in other examples, other forms of bearing may be used.

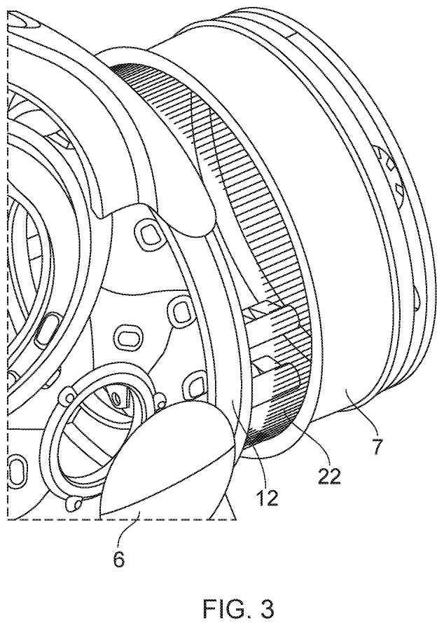

In the examples illustrated in FIGS. 2 and 3, the bearing 16 is provided with a plurality of boltholes 14 which are disposed around a circumference the bearing 16. The plurality of boltholes 14 are each configured to receive a corresponding connector 22 provided at the root end of the wind turbine blade 7.

In the example illustrated in FIG. 3, the plurality of connectors 22 are provided as a series of bolts which are configured to be received within each of the plurality of boltholes 14 where they can be secured with a suitable fastener (such as a barrel nut) thereby facilitating connection between the rotor hub 6 and the turbine blade 7. However, it shall be appreciated that other suitable connectors may instead be used.

Furthermore, in some examples, the plurality of connectors may be disposed around the circumference of the bearing 16 for insertion into boltholes 14 provided at the root end of the wind turbine blade 7.

The rotatable bearing 16 is rotatably coupled to the mounting 12 in a manner which permits axial rotation of the bearing 16, thereby allowing for pitch-wise rotation of the wind turbine blade 7 (which is mounted to the bearing 16) relative to the rotor hub 6.

The pitch of each turbine blade 7 is adjusted via one or more blade pitch actuators 18 which are housed within the cavity of the rotor hub 6 at or proximal to the mounting 12. In some examples, the blade pitch actuators 18 may be provided as one or more hydraulic cylinders. In other examples, different types of actuator (such as electric actuators) may be utilised.

The blade pitch actuators 18 are controlled via a pitch control system (not shown) which may alter the pitch of the turbine blades 7 coupled to the mounting 12 via activating the corresponding blade pitch actuators 18 so as to cause the actuators 18 to rotate the rotatable bearing 16 to which the turbine blade 7 is mounted. Typically, the pitch control system will alter the pitch of the turbine blade 7 based on various factors (such as wind speed, power demand etc.) to increase or decrease the rotational speed of the rotor 5, thereby regulating the power output of the wind turbine 1. However, in some circumstances, the pitch control system may also control the blade pitch actuators 18 to move the blades into a zero lift (or “feathered”) position when wind speeds are too high for the wind turbine 1 to safely operate. The means by which the pitch of the one or more wind turbine blades 7 can be adjusted is not central to the examples of the invention and hence shall not be described in further detail.

As set out within the Background section above, positioning the wind turbine blade 7 and rotor hub 6 so that each of the boltholes 14 align with their corresponding connector 22 is incredibly difficult. One of the primary reasons for this is that high winds acting on the blade 7 and tower 3 during installation will cause relative movement between the blades 7 and the rotor hub 6. This problem is further exacerbated when the wind turbine 1 is an offshore installation since tidal motions can further add to the relative movement between these components.

To address this issue, a blade guiding apparatus is provided to help account for and mitigate the issues caused by relative movement between the rotor hub 6 and the turbine blade 7 during installation.

The blade guiding apparatus is made up of a guide 100 and a cushion 120 which is carried by the guide 100. In the example illustrated in FIG. 2, the blade guiding apparatus comprises a pair of guides 100 each carrying a respective cushion 120. However, it shall be appreciated that in other examples, the blade guiding apparatus may be made up of a different number of guides and corresponding cushions, such as 1, 3, 4, 5, 6, 7, 8 etc.

In the example illustrated in FIG. 2, the guides 100 are mounted to the rotor hub 6 such that (during use) the cushion 120 is configured to form an interference fit with an internal surface of the wind turbine blade 7 (as shall be described in greater detail later within this application).

In the illustrated example, the first guide 100 is disposed at a first position about a circumference of the mounting 12, inboard of the bearing 16, and the second guide 100 is disposed at a second position about the circumference of the mounting 12, also inboard of the bearing 16.

In the example illustrated in FIG. 2, the first guide 100 is disposed at approximately a 12 o'clock (or 0 degree) position about the circumference of the mounting 12 whilst the second guide 100 is disposed about the circumference of the mounting 12 at approximately a 6 o'clock (or 180 degree) position. Consequently, the first and second guides are separated by an arc having a central angle which is approximately 180 degrees. Advantageously, positioning the first and second guides at the 12 o'clock and 6 o'clock positions allows the blade guiding apparatus to perform vertical adjustments of the rotor hub 6 relative to the turbine blade 7 during installation.

In alternative examples, the first guide 100 may be disposed at approximately a 3 o'clock (or 90 degree) position about the circumference of the mounting 12 and the second guide 100 may be disposed about the circumference of the mounting 12 at approximately a 9 o'clock (or 270 degree) position. Advantageously, positioning the first and second guides at the 3 o'clock and 9 o'clock positions allows the blade guiding apparatus to be used to perform lateral adjustments of the rotor hub 6 relative to the turbine blade.

The means by which said lateral and vertical adjustments can be achieved shall be described in greater detail at a later part of this application.

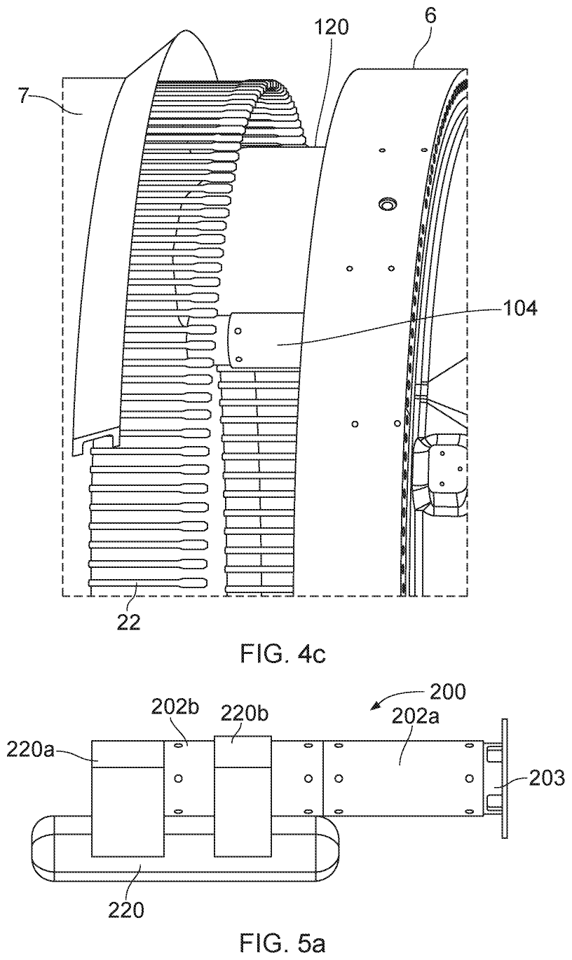

It shall also be appreciated that in other examples, a different number of guides 100 and cushions 120 may be provided and/or the guides and cushions may be disposed at different positions about the rotor hub 6. Furthermore, in some examples, neighbouring guides may be separated by an arc having a central angle which is more or less than 180 degrees. In examples where the number of guides/cushions is greater than two, neighbouring guides may be separated by an arc having a central angle of 360/N wherein N is the number of guides/cushions. Furthermore, in some examples (such as the example illustrated in FIG. 5b), the guides 100 may be irregularly spaced about the wind turbine blade 7 or rotor hub 6.

It shall also be appreciated that in some examples, the guide 100 may be mounted to the turbine blade 7 such that (during use) the cushion 120 is configured to form an interference fit with an internal surface of the rotor hub 6. Advantageously, since the rotor hub 6 is typically formed from a cast metal (which is stronger than the glass or carbon fibre reinforced composite material used to form the blade 7), using a configuration which allows the interference fit to be created at the stronger rotor hub 6 casting rather than at the blade 7 can help to reduce the likelihood of the blade 7 becoming damaged during installation.

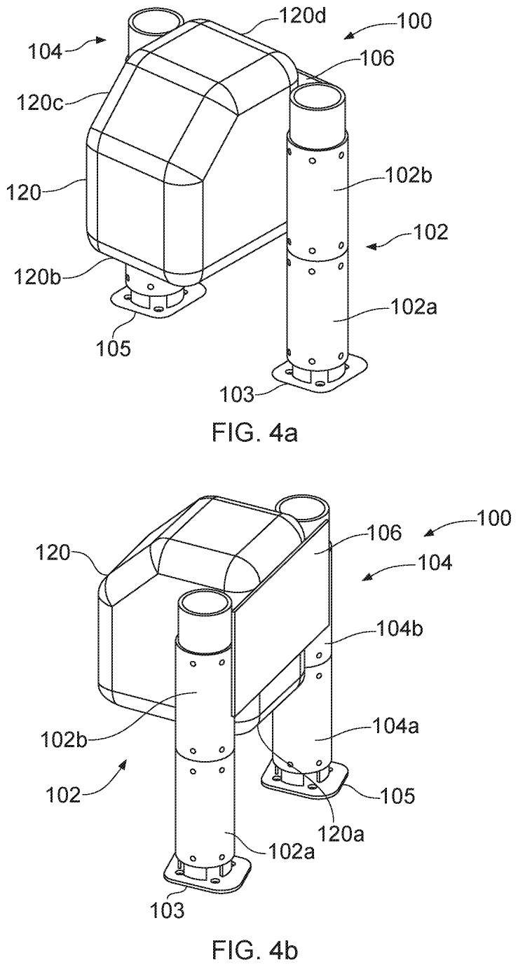

The blade guiding apparatus shall now be described in greater detail with reference to FIGS. 4a and 4b.

In the example illustrated in FIGS. 4a and 4b, the guide 100 includes a pair of (first and second) posts 102, 104 and a cradle 106 extending between said posts 102, 104 for supporting the cushion 120. In other words, the 120 cushion is carried between the first 102 and second 104 posts.

The first 102 and second posts 104 are provided as a pair of elongate, cylindrical projections each comprising a respective mounting 103, 105 to facilitate attachment of the posts 102, 104 to either the rotor hub 6 or the root end of a wind turbine 7.

In the example illustrated in FIG. 4a, the first 102 and second posts 104 are provided as a plurality of releasably connectable sections. In particular, the first 102 and second 104 posts are made up of a root section 102a, 104a to which the mountings 103, 105 are connected, and a tip section 102b, 104b to which the cradle 106 is connected. The root 102a, 104a and tip 102b, 104b sections may be connected via a screw thread, a ferrule, a quick-release clasp, or any other suitable connector type. It shall also be appreciated that in some examples, the posts 102, 104 may be provided as single, monolithic structures.

In the example illustrated in FIGS. 4a and 4b, the cradle 106 is provided as a single, substantially flat sheet of material having a first end which is coupled to the tip portion 102b of the first post 102 and a second end which is coupled to the tip portion 104b second post 104. However, it shall be appreciated that in other examples, other suitable types of cradle 106 may be used. The cradle 106 may be coupled to the first 102 and second 104 posts via a weld, an adhesive joint, one or more releasable connectors, fasteners, or any other suitable type of coupling.

In the illustrated example, the posts 102, 104 are manufactured from a fibre-reinforced composite material such as a carbon fibre reinforced composite or a glass fibre reinforced composite. Advantageously, the use of fibre-reinforced materials helps to provide the posts with the desired levels of stiffness to help prevent them from bending during use whilst also keeping the structure lightweight, thereby making it easier to hoist and/or secure the guide to the rotor hub or wind turbine blade during use.

In fact, in the illustrated example, the posts 102, 104 are provided as a plurality of releasably connectable sections and the weight of each section is less than 20 kg. This allows the blade guiding apparatus to be easily transported into the nacelle 2 and assembled on site. However, it shall be appreciated that in other examples, the posts may be manufactured from other materials such as aluminium or high-strength polymeric materials and hence may have a weight which is greater than 20 kg.

Typically, the cradle 106 is manufactured from the same material as the posts 102, 104 although in some examples a different material may be used.

Considering now the cushion 120, the cushion 120 is configured to form an interference fit with either the rotor hub 6 or wind turbine blade 7 (depending on which component the guide 100 is mounted to).

Typically, the cushion 120 is made from a resilient, high friction material such as EDPM or rubber, although it shall be appreciated that in some examples, other suitable materials may be used.

In the example illustrated in FIGS. 4a to 4c, the cushion 120 has an irregular pentagonal cross-sectional shape and comprises a first surface 120a which is configured to interface with the cradle 106 and three engaging surfaces 120b-d which extend outwardly beyond the guide 100 for interfacing with an internal surface of the turbine blade 7 (or rotor hub 6 in other examples) when the rotor hub 6 and turbine blade 7 are brought into engagement (as shown in FIG. 4c).

In some examples, the first surface 120a of the cushion 120 may comprise a series of hooked patches configured to engage with corresponding looped patches (or vice versa) provided on the cradle 106 to secure the cushion 120 to the guide 100. In other examples, the cushion 120 may be secured to the cradle via one or more connectors, an adhesive, or any other suitable means.

In the illustrated example, the three engaging surfaces 120b-d are substantially flat and each have a different orientation. Upper 120b and lower 120d engaging surfaces are provided which are orientated substantially perpendicularly to one another. An intermediate engaging surface 120c is also provided between the upper 120b and lower 120 d engaging surfaces which is angled at approximately 45 degrees to the upper 120b and lower 120d surfaces. Consequently, the engaging surfaces 120b-d form a roughly curved profile which corresponds to the profile of the internal surface of the turbine blade 7 or rotor hub 6 with which the surfaces 120b-d will engage.

However, it shall be appreciated that in other examples, the cushions may be provided in any other suitable shape or configuration. For example, in some examples, the cushion 120 may comprise a single, curved engaging surface instead of three flat engaging surfaces provide at different orientations. In other example, the cushions may be square, rectangular, spherical, or cylindrical in shape.

A blade guiding apparatus according to another example of the present disclosure is illustrated in FIGS. 5a and 5b.

As with the apparatus described in FIGS. 4a-4c, the blade guiding apparatus is made up of a guide 200 and a cushion 220 which is carried by the guide 200. However, unlike the guide described in FIGS. 4a-4c in which the cushion 120 is carried on a cradle 106 provided between first 102 and second 104 posts, in the example depicted in FIGS. 5a and 5b the guide is provide as a single post 202.

The post 202 is provided as an elongate, cylindrical projection and has an associated mounting 203 to facilitate attachment of the post 202 to either the rotor hub 6 or the root end of a wind turbine 7.

In the example illustrated in FIG. 5a, the post 202 is provided as a plurality of releasably connectable sections. In particular, the post 202 is made up of a root section 202a to which the mounting 203 is connected, and a tip section 202b which carries the cushion 220. The root 202a and tip 202b sections may be connected via a screw thread, a ferrule, a quick-release clasp, or any other suitable connector type. It shall also be appreciated that in some examples, the post 202 may be provided as a single, monolithic structure.

In the illustrated example, the guide 200 is manufactured from a fibre-reinforced composite material such as a carbon fibre reinforced composite or a glass fibre reinforced composite. Advantageously, the use of fibre-reinforced materials helps to provide the post with the desired levels of stiffness to help prevent it from bending during use whilst also keeping the structure lightweight, thereby making it easier to hoist and/or secure the guide to the rotor hub or wind turbine blade during use.

In fact, in the illustrated example, the guide 200 is provided as a plurality of releasably connectable sections wherein the weight of each section is less than 20 kg. This allows the blade guiding apparatus to be easily transported into the nacelle 2 and assembled on site. However, it shall be appreciated that in other examples, the posts may be manufactured from other materials such as aluminium or high-strength polymeric materials and hence the weight of the section may be greater than 20 kg.

Considering now the cushion 220, as with the cushion 120 described in FIGS. 4a to 4c, the cushion 220 depicted in FIG. 5a is made from a resilient, high friction material such as EDPM or rubber, although it shall be appreciated that in some examples, other suitable materials may be used.

The cushion 220 depicted in FIGS. 5a and 5b is provided in the form of a substantially cylindrical (or sausage-shaped) fender which is secured to the post 202 via a pair of straps 220a, 220b which extend around the circumference of the tip portion 202b of the post 202.

In the illustrated example, four guides 200 and associated cushions 220 are provided which are disposed about a circumference of the mounting 12, inboard of the bearing 16. As shown in FIG. 5b, a pair of guides 200 and associated cushions 220 are disposed at approximately a 12 o'clock (or 0 degree) position about a circumference of the mounting 12 whilst another pair of guides 200 and associated cushions 220 are disposed about a circumference of the mounting 12 at approximately a 6 o'clock (or 180 degree) position.

However, as with the example described in relation to FIG. 4 above, in other examples a different number of guides/cushions may be provided and in some examples the guides/cushions may be disposed at different positions about the rotor hub 6 (or wind turbine blade in other examples).

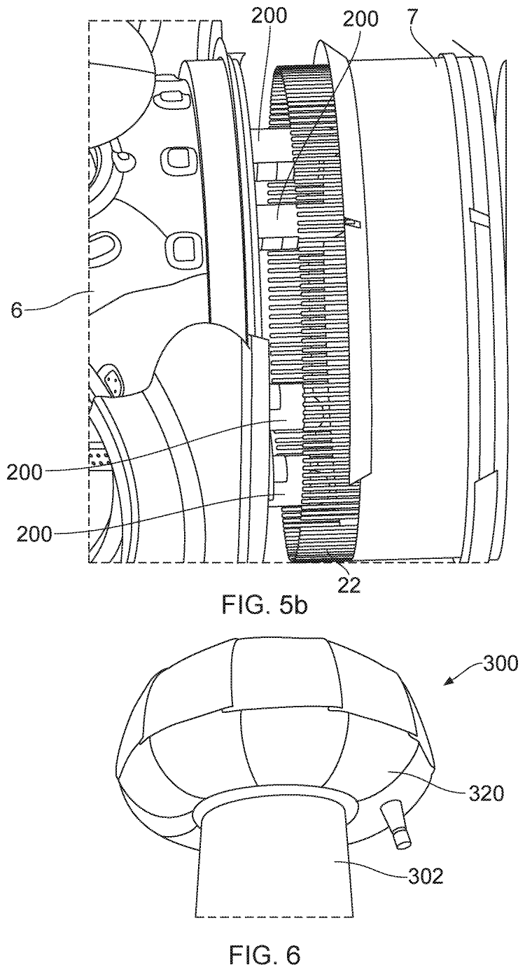

A blade guiding apparatus according to yet another example of the present disclosure is illustrated in FIG. 6.

The blade guiding apparatus described in FIG. 6 has many features in common with that which is described in FIG. 5a and so, for the sake of conciseness, only the differences shall be described herein. Corresponding features have been denoted with like reference numerals.

As with the blade guiding apparatus described in FIG. 5a, in the example depicted in FIG. 6 the guide 300 comprises a single post 302 having a root portion (not shown) and a tip portion which carries the cushion 320.

However, unlike the cushion 220 depicted in FIG. 5a, the cushion 320 of the example illustrated in FIG. 6 is provided as a substantially torus-shaped (or doughnut-shaped) ring which extends around a circumference of the tip portion of the post 302 (which constitutes the guide 300). The guide 300 is received in the “hole” defined by the cushion 320.

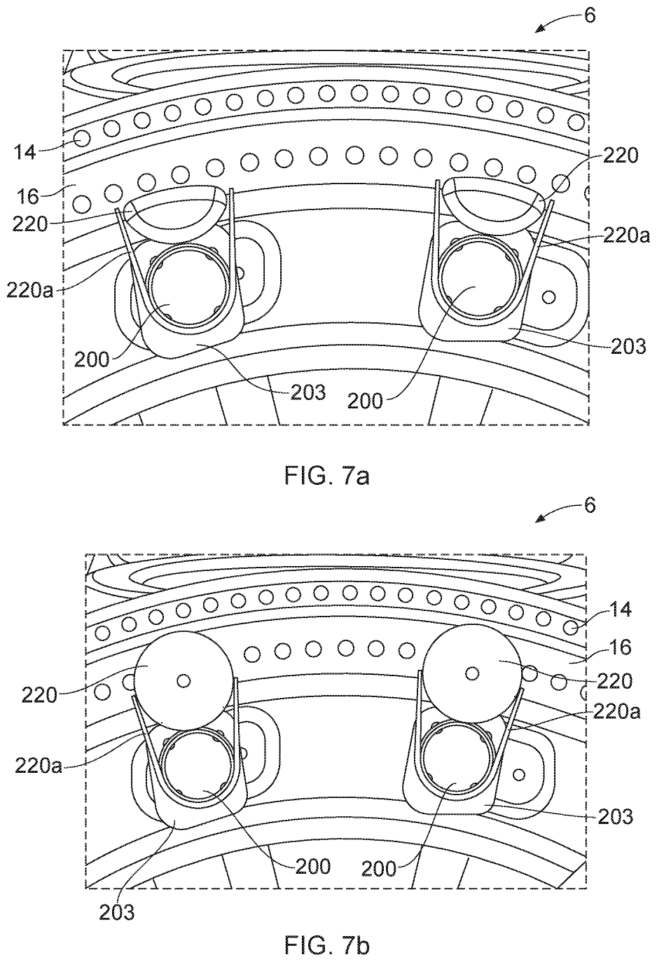

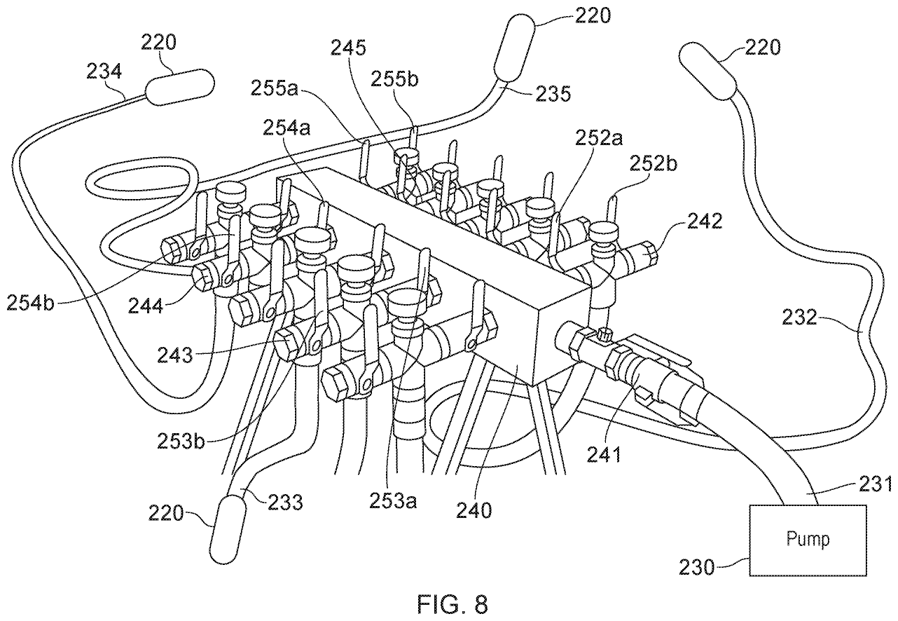

Returning to the example illustrated in FIGS. 5a and 5b, whilst in some examples the cushion(s) may have a substantially constant volume, in other examples the cushion(s) may be inflatable as depicted in FIGS. 7 and 8.

In such examples, a pumping device 230 may be provided in fluid connection with one or more of the cushions 220 to allow the cushions 220 to be actuated from a first condition in which the cushions 220 are uninflated or partially inflated (as shown in FIG. 7a) to a second condition in which the cushions 220 are fully inflated (as shown in FIG. 7b). As will be described in greater detail below, in some examples the cushions 220 may be independently inflatable, whereas in other examples the cushions 220 may be inflated altogether as a group.

In the illustrated example, the pumping device 230 is provided in the form of a compressor which is configured to inflate the plurality of cushions 220 via filling them with air drawn from the ambient atmosphere. However, it shall be appreciated that other suitable kinds of pumping device may also be used. Furthermore, it shall also be appreciated that in other examples, other gases or fluids such a water, hydrogen, helium etc. (which may be provided in a separate cannister or the like) may be used to inflate the cushions.

In some examples, the cushions 220 may be fluidly connected to the pumping device 230 via a manifold 240 such as that which is depicted in FIG. 8.

The manifold 240 depicted in FIG. 8 has an inlet port 241, which is fluidly connected to the pumping device 230 via a first hose 231, and a plurality of outlet ports 242-245, which are each connected to a respective cushion 220 via an associated hose 232-235. In the example illustrated in FIG. 5, the blade guiding apparatus has four cushions and hence at least four outlet ports 242-245 are provided at the manifold 240. However, it shall be appreciated that in examples where a different number of cushions 220 are provided, the manifold 240 may have a different number of outlets.

It shall also be appreciated that in some examples, the manifold may be omitted and hence the pumping device 230 may instead be directly connected to some or all of the cushions 220 via a suitable hose arrangement or the like.

In some examples, the cushions 220 may be associated with one or more valves to provide a controllable fluid connection between the cushions 220 and the pumping device 230 thereby allowing the cushions to be independently inflated or deflated. Alternatively, in some examples, each cushion 220 may be provided with its own pumping device, which also allows the cushions to be independently inflated. Advantageously, the provision of independently inflatable cushions allows the blade guiding apparatus to adjust (or fine tune) the alignment of the rotor hub 6 with the turbine blade 7 via selectively inflating or deflating one or more of the cushions during installation (as will be described in greater detail in the method section below).

In the example illustrated in FIG. 8, each cushion is associated with a pair of two-way, two-position (or 2/2) valves 252a-255a and 252b-255b which are located at the manifold 240 proximal to the respective outlets 242-245. Advantageously, providing the valves in close proximity at the manifold 240 allows them to be more easily accessed and operated via a user.

The first set of valves 252a-255a are configured to control the fluid connection between the pumping device 230 and the respective cushions thereby allowing the cushions 220 to be selectively and controllably inflated. The first set of valves 252a-255a are each independently moveable between a first position in which the associated cushion is not placed in fluid communication with the pumping device 230 (and hence will not be inflated), and a second position in which a fluid connection is established between the associated cushion 220 and the pumping device 230.

In the example depicted in FIG. 8, each of the respective outlets 242-245 has an open end to allow the egress of fluid into the ambient atmosphere. The second set of valves 252b-255b are configured to control the fluid connection between the cushions 220 and the ambient atmosphere thereby allowing the cushions 220 to be selectively and controllably deflated via allowing fluid to exit the cushion via the open ends of each outlet 242-245. The second set of valves 252b-255b are each independently moveable between a first position in which a fluid connection is established between the associated cushion 220 and the ambient atmosphere via the open ends of each outlet 242-245, and a second position in which the associated cushion is not placed in fluid communication with the ambient atmosphere.

Consequently, when the pumping device 230 is activated and one or more of the valves 252-255 are placed in the second position, ambient air will be sucked into the compressor, pass into the manifold 240 via the hose 231, pass through the respective outlets 242-245 and into the cushions 220 thereby causing the cushion(s) 220 associated with said valves to expand from a first, uninflated or partially inflated, condition (as shown in FIG. 7a) to a second, fully inflated, condition (as shown in FIG. 7b).

Conversely, when one or more of the valves 252-255 are placed in the first position, ambient air will be allowed to pass from the cushion(s) 220 associated with said valves to the ambient atmosphere via the open ends of the respective outlets 242-245 provided in the manifold 240 thereby causing the cushions 220 to deflate from the second, fully inflated, condition (as shown in FIG. 7b) to the first, uninflated or partially inflated, condition (as shown in FIG. 7a).

It shall be appreciated that whilst in the illustrated example a pair of 2/2 valves are provided, in other examples a similar functionality may be provided by a single three-way, two-position (or 3/2) valve and so in some examples, only a single valve may be associated with each cushion.

Furthermore, it shall also be appreciated that whilst in the illustrated examples the valves are provided at manifold 240, in other examples the valves may be provided at any point along the fluid connection between the pumping device and the cushions or in some examples may be provided at the cushion itself.

It shall also be appreciated that whilst the inflatable functionality of the blade guiding apparatus is described with reference to the examples depicted in FIGS. 5a and 5b, it shall also be appreciated that the cushions of blade guiding apparatuses of the type illustrated in FIGS. 4a-c and FIG. 6 may also be inflatable in substantially the same manner as that which is described above.

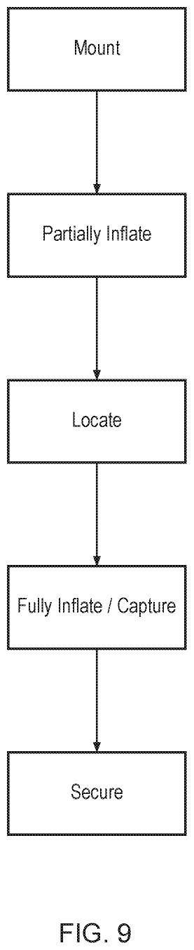

A method of securing a wind turbine blade 7 to a rotor hub 6 using the blade guiding apparatus according to examples of the present disclosure shall now be described with reference to FIG. 9.

It shall be appreciated that whilst the method described below is described with reference to the blade guiding apparatus depicted in FIGS. 5, 7 and 8, the same method is also applicable for other blade guiding apparatuses such as those depicted in FIGS. 4 and 6.

Furthermore, whilst the method below is described in relation to an example in which the blade guiding apparatus is secured to the rotor hub 6, it shall be appreciated that substantially the same method may bef utilised for examples in which the blade guiding apparatus is secured to the wind turbine blade 7.

In a first step of the method, the guide 200 is mounted to one of a rotor hub 6 or the root end of a wind turbine blade 7 (in this instance a rotor hub 6). In the example shown in FIG. 7a, the pair of guides 200 are mounted to the rotor hub mounting 12, inboard of the bearing 16, at approximately a 12 o'clock position about the circumference of the mounting 12 such that the tip portion of the guides 200 extends beyond the rotor hub 6. A pair of corresponding guides 200 (not shown) are also mounted to the rotor hub mounting 12, inboard of the bearing 16, at approximately a 6 o'clock position about the circumference of the mounting 12. However, it shall be appreciated that in other examples, the guides 200 may be mounted at different positions.

As shown in FIG. 7a, the guides 200 are mounted such that the cushions 220 are outwardly facing. Once the guides 200 have been mounted, the cushions 220 may be partially inflated to a first condition as shown in FIG. 7a. When the cushions 220 are in the first condition, a clearance of between 150 mm and 500 mm may be provided between the outermost surface of the cushion 220 and the bearing 16.

The rotor hub 6 and the root end of the wind turbine blade 7 are then brought together such that the plurality of connectors 22 provided at the root end of the wind turbine blade 7 can become aligned with the corresponding boltholes 14 provided on the rotor hub 6.

The root end of the wind turbine blade 7 is substantially cylindrical in shape and is made up of a hollow body which defines a cavity. As such, as the rotor hub 6 and the wind turbine blade 7 are brought together, the tip portions of the guides 200 become located in the cavity of the wind turbine blade 7.

Advantageously, by inserting the guides 200 when the cushions 220 are in a partially inflated state, the cushions 220 are able to dampen and absorb any incidental impacts between the guides 200 and the connectors 22 (provided at the root end of the wind turbine blade 7) due to relative movement between the rotor hub 6 and the turbine blade 7 during installation, thereby helping to prevent damage being caused to the guide 200 or the connectors 22.

Furthermore, since the cushions 220 are only partially inflated, a relatively large tolerance (or clearance) is still provided between the bearing 16 and the cushion 220 thereby allowing the guides 200 to be easily located within the cavity of the blade 7 even when the rotor hub 6 and turbine blade 7 are moving relative to each other.

Once the tip portion of the guide 200 is located within the cavity of the wind turbine blade 7, the cushions undergo a second inflation causing them to expand from a first, partially inflated condition (in which the cushions 220 have a first volume), to a second, fully inflated condition (in which the cushions 220 have a second volume which is greater than the first volume).

Upon being inflated from the first condition to the second condition, the cushions 220 being to urge against one or more of the internal surfaces of the wind turbine blade 7 within the cavity as shown in FIG. 7b thereby forming an interference fit between the guide 200 and the wind turbine blade 7.

When the cushions 220 are in the second condition and an interference fit has been formed, the turbine blade 7 is essentially “captive” and hence relative movements between the rotor hub 6 and turbine blade 7 are significantly reduced and confined.

This makes it much easier for an operator to align and secure the connectors 22 provided at the root end of the turbine blade 7 to the boltholes 14 provided on the rotor hub 6 and hence the connection of the wind turbine 7 to the rotor hub 6 can be more easily facilitated.

Furthermore, in some examples in which the plurality of cushions are independently inflatable, during or after the second inflation, one or more of the cushions may be selectively inflated or deflated to help better align the rotor hub 6 with the turbine blade 7 as shall be described below.

For example, during installation, an operator may determine that the rotor hub 6 and the wind turbine 7 are not in the correct vertical alignment. Consequently, the operator may control the pumping device and/or valves associated with the cushions 220 to inflate the cushions provided at the 12 o'clock position and/or to deflate the cushions 220 provided at the 6 o'clock position (or vice versa) in order to move the wind turbine blade 7 up or down relative to the rotor hub 6 as may be required to correctly align the two components.

Similarly, in examples in which guides and cushions are provided at the 3 o'clock and 9 o'clock positions, an operator may determine that the rotor hub 6 and the wind turbine blade 7 are not in the correct lateral alignment. Consequently, the operator may control the pumping device and/or valves associated with the cushions to inflate the cushions provided at the 3 o'clock position and/or to deflate the cushions provided at the 9 o'clock position (or vice versa) in order to move the wind turbine blade 7 left or right relative to the rotor hub 6 as may be required to correctly align the two components.

Once the rotor hub 6 and wind turbine 7 are correctly aligned, the connectors 22 can then be secured within the corresponding boltholes 14.

It shall also be appreciated that in some examples, it is not always possible to access all the connectors 22 required to securely connect the wind turbine blade 7 to the rotor hub 6. As such, in some examples, the wind turbine blade 7 may need to be rotated (or pitched) about its longitudinal axis to allow an operator to access and secure all the connectors 22.

Before the wind turbine blade 7 can be pitched, it is first secured to the rotor hub 6 via a first set of connectors (not shown) which are accessible to an operator when the wind turbine 7 is orientated at a first pitch.

Once the first set of connectors have been secured, it is desirable to rotate the wind turbine blade from the first pitch to a second pitch to allow an operator to access and secure a second set of connectors which are inaccessible to the operator when the blade 7 is orientated in the first pitch. This is done via activating one or more of the blade pitch actuators 18 (e.g., via the pitch control system) to cause the rotatable bearing 16 (and hence the wind turbine blade 7 mounted thereto) to rotate in a pitch-wise direction about its longitudinal axis from the first pitch to the second pitch.

However, it is not possible to activate the blade pitch actuators 18 when the guides 200 of the blade guiding apparatus are mounted to the rotor hub 6 since they would interfere with the blade pitch actuators 18 which are also provided inboard of the rotatable bearing 16. Therefore, before the blade pitch actuators 18 are activated, the root portions of the guides 200 must be detached from the rotor hub 6.

In some examples in which the guide or guides are provided as a plurality of releasably detachable sections, the tip portion of the guide 200 (which carries the cushion 220) may be detached from the root portion of the guide whilst the tip portion and cushion 220 remain in-situ within the cavity of the wind turbine blade 7 (and prior to the root portion of the guide 200 being detached from the rotor hub 6). Advantageously, this helps to reduce construction times since the turbine blade can be pitched to allow access to some of the (previously inaccessible) connectors without having to disconnect and dissemble the entire blade guiding assembly.

Once the root portion of the guide 200 has been detached from the rotor hub 6, the wind turbine blade 7 is rotated from the first pitch to the second pitch, which allows the operator to access the second set of connectors (not shown). The second set of connectors can then be secured and fastened thereby completing the installation of the blade 7 onto the rotor hub 6.

This process is then repeated for each of the blades 7 until each blade is securely connected to the rotor hub 6.

Although the invention has been described above with reference to one or more preferred examples, it will be appreciated that various changes or modifications may be made without departing from the scope of the invention as defined in the appended claims.

It shall also be appreciated that the blade guiding apparatus according to examples of the present disclosure may be used in combination with one or more types of other passive alignment guides (such as “Shark Fin” guides or the like). In some examples, these other forms of passive alignment guide may be disposed at positions approximately 90 degrees to the positions at which the guides of the present disclosure are disposed.

1. A blade guiding apparatus for facilitating connection between a wind turbine blade and a rotor hub, the blade guiding apparatus comprising:
a guide; and
a cushion carried by said guide for forming an interference fit with a wind turbine blade or with a rotor hub.

2. The blade guiding apparatus according to claim 1, wherein the cushion is an inflatable cushion.

3. The blade guiding apparatus according to claim 1, wherein the cushion extends around a circumference of the guide.

4. The blade guiding apparatus according to claim 1, wherein the guide comprises a first post and a second post, and wherein the cushion is carried between the first and second posts.

5. The blade guiding apparatus according to claim 1, wherein the blade guiding apparatus comprises a plurality of guides, and wherein each guide carries a respective cushion.

6. The blade guiding apparatus according to claim 5, wherein each cushion is independently inflatable.

7. The blade guiding apparatus according to claim 2 further comprising a pumping device configured to actuate the or each cushion from an uninflated condition to an inflated condition.

8. The blade guiding apparatus according to claim 7, wherein the or each cushion is associated with a valve for providing a controllable fluid connection between the pumping device and the cushion and/or between the cushion and the ambient atmosphere.

9. The blade guiding apparatus according to claim 7, wherein the or each cushion is associated with a first valve for providing a controllable fluid connection between the pumping device and the cushion, and wherein the or each cushion is associated with a second valve for providing a controllable fluid connection between the cushion and the ambient atmosphere.

10. The blade guiding apparatus according to claim 8, wherein each cushion is fluidly connected to the pumping device via a manifold, and wherein the first and/or second valves are provided at said manifold.

11. The blade guiding apparatus according to claim 1, wherein the or each guide is formed from a plurality of releasably connectable sections, wherein the weight of each section is less than 20 kg.

12. A wind turbine comprising:
a rotor hub;
a wind turbine blade; and
the blade guiding apparatus according to claim 1,
wherein the guide is mounted to one of the rotor hub or the wind turbine blade, and
wherein the cushion is configured to form an interference fit with the other of the rotor hub or the wind turbine blade.

13. The wind turbine according to claim 12, wherein the blade guiding apparatus comprises a plurality of guides, and wherein the plurality of guides are provided at different positions about a circumference of the rotor hub or wind turbine blade.

14. The wind turbine according to claim 13, wherein a first guide is provided at a first position about the circumference of the rotor hub or wind turbine blade, wherein a second guide is provided at a second position about the circumference of the rotor hub or wind turbine blade, and wherein the first and second positions are separated by an angle of approximately 180 degrees.

15. The wind turbine according to claim 12, wherein the guide is mounted to the rotor hub and wherein the cushion is configured to form an interference fit with the wind turbine blade.

16. A method of securing a wind turbine blade to a rotor hub using the blade guiding apparatus according to claim 1, the method comprising:
a) mounting the guide to one of a rotor hub or a wind turbine blade;
b) locating at least part of the guide in the other of the rotor hub or the wind turbine blade; and
c) forming an interference fit between the cushion carried by the guide and the rotor hub or wind turbine blade into which the guide is located.

17. The method according to claim 16, wherein the cushion is an inflatable cushion, and wherein the method further comprises at least partially inflating the cushion prior to locating at least part of the guide in the rotor hub or wind turbine blade.

18. The method according to claim 16, wherein the cushion is an inflatable cushion, and wherein the method comprises, after locating the guide in the rotor hub or wind turbine blade, inflating or further inflating the cushion from a first condition, in which the cushion does not form an interference fit with the rotor hub or wind turbine blade, to a second condition, in which the cushion forms an interference fit with the wind turbine blade or rotor hub.

19. The method according to any of claims 16, wherein the blade guiding apparatus comprises a plurality of independently inflatable cushions, and wherein the method further comprises, after locating the guide in the rotor hub or wind turbine blade, selectively inflating and/or deflating one or more of the plurality of cushions so as to align the wind turbine blade with the rotor hub.

20. The method according to claim 16, wherein the guide comprises a root portion and a tip portion for carrying the cushion, wherein the blade is secured to the rotor hub via a first set of connectors which are accessible when the blade is at a first pitch and a second set of connectors which are inaccessible when the blade is at the first pitch, and wherein the method comprises:
d) securing the wind turbine blade to the rotor hub via the first set of connectors;
e) detaching the tip portion of the guide from the root portion of the guide;
f) detaching the root portion of the guide from the rotor hub whilst the tip portion of the guide remains secured to the wind turbine blade via the interference fit formed between the cushion and the wind turbine blade;
g) rotating the wind turbine blade from a first pitch to a second pitch in which the second set of connectors are accessible; and
h) securing the wind turbine blade to the rotor hub via the second set of connectors.
